(19) United States
(12) Patent Application Publication
(10) Pub. No.: US 2026/0058847 A1
(43) Pub. Date: Feb. 26, 2026

(54) CHANNEL ESTIMATION METHOD OF MULTI-DIMENSIONAL FEATURE AGGREGATION NETWORK BASED ON AUV WIRELESS COMMUNICATION SYSTEM

(71) Applicant: Harbin Engineering University, Harbin (CN)

(72) Inventors: Yan SUN, Harbin (CN); Jiajia ZHOU, Harbin (CN); Jiangzhi FU, Harbin (CN); Hang JIANG, Harbin (CN); Yihang LUO, Harbin (CN); Yang WU, Harbin (CN)

(73) Assignee: Harbin Engineering University, Harbin, HL (CN)

(21) Appl. No.: 19/378,335

(22) Filed: Nov. 4, 2025

(30) Foreign Application Priority Data
Nov. 4, 2024 (CN) 202411560041.6

(51) Int. Cl. H04L 25/02; G06N 20/00; H04L 27/26

(52) U.S. Cl. CPC H04L 25/0254; G06N 20/00; H04L 25/0228; H04L 27/2647

(57) ABSTRACT

The invention discloses method of improving AUV wireless communications systems, including steps of: collecting the channel frequency response and receiving signal data in the electromagnetic environment where AUV works on the water surface,; constructing a multi-dimensional feature aggregation network model based on self-attention mechanism; training a multi-dimensional feature aggregation network; and preprocessing received AUV signals to obtain improved input data. The network model completed by offline training is loaded, and the input data is input into the network for channel estimation. The invention uses a self-attention mechanism in deep learning to build a multi-dimensional feature aggregation network model. The estimation performance is much higher than the traditional channel estimation method, and the space-time complexity of the network is very low, which can be applied to an AUV wireless communication system through offline training.

### TECHNICAL FIELD

The invention relates to the field of wireless communication signal processing technology, in particular to a channel estimation method based on a multi-dimensional feature aggregation network based on an autonomous underwater vehicle (AUV) wireless communication system.

### BACKGROUND

An AUV is a device that no one drives and automatically controls underwater navigation. When an AUV communicates on the water surface, there are many requirements for the prediction of the communication environment, among which the estimation of the channel frequency response is particularly important. According to the results of channel frequency response estimation, AUVs can not only compensate for the signal fading to ensure the reliability of communication, but also adaptively adjust the modulation and coding scheme of the transmitter to adapt to the current channel environment. Therefore, ‘channel estimation’ is an indispensable link in the surface communication of AUVs.

The traditional channel estimation methods mainly include pilot-based LS estimation and MMSE (Minimum Mean Square Error) estimation. LS estimation ignores the influence of noise and only involves one division operation, which is simple and easy to implement. However, with the increasing complexity of the marine electromagnetic environment and the increasing intensity of electromagnetic interference in a crowded environment, its estimation performance cannot meet the requirements of AUV surface communication. The complexity of MMSE estimation is very high, involving two matrix inversions, and requires accurate channel statistical information and noise variance. Although MMSE estimation has extremely high estimation performance, it is difficult to implement in reality.

In recent years, with the development of deep learning, more and more researchers have used deep learning methods to implement channel estimation, and those experiments get the good results. The existing channel estimation methods based on deep learning, such as ChannelNet and CRCENet, have much higher estimation performance than traditional channel estimation methods. However, these networks are designed for channel estimation of terrestrial communication, and their communication environment is not as complex and changeable as that of maritime communication. Additionally, these networks have extremely high computational complexity and are difficult to implement on AUV hardware devices.

### SUMMARY

The purpose of this invention is to provide a channel estimation method using a multi-dimensional feature aggregation network based on an autonomous underwater vehicle (AUV) wireless communication system, wherein the space-time complexity of the network model is low. It can be applied to AUV through offline training to achieve far better estimation performance than traditional channel estimation methods, and then solve the above technical problems in the existing technology. The invention can further be utilized to improve range, effectiveness and reliability of USV wireless communications in maritime environments.

In order to achieve the above purpose, the invention provides a channel estimation method of a multi-dimensional feature aggregation network based on an AUV wireless communication system, including the following steps:
S1, collecting a channel frequency response and received signal data in an electromagnetic environment where an AUV works on a water surface, extracting a pilot signal from received signals, and using an interpolation method based on DPA estimation to upsample the pilot signal as an input data of a model to be trained; using a channel frequency response in collected data as a training label and corresponding the training label to the received signal data to form a data set;
S2, constructing a multi-dimensional feature aggregation network model based on a self-attention mechanism; wherein a multi-dimensional feature aggregation network model FACENet based on the self-attention mechanism includes a multi-dimensional feature aggregation module, a feature processing module, and an upsampling module;
S3, in the multi-dimensional feature aggregation network model established in S2, using the data set collected in S1 for offline training to obtain a trained network model;
S4, when the AUV works on the water surface, preprocessing the received signal at a receiving end of the AUV to obtain input data of the network model trained in S3;
S5, inputting the input data obtained in S4 into the network model trained by S3, and estimating a real channel frequency response of the AUV environment to complete a channel estimation.

In some embodiments, in S1, using the interpolation method based on DPA estimation to upsample the pilot signal includes the following steps:
for a first OFDM symbol and an eighth OFDM symbol, performing an LS estimation at a pilot position;
using the LS estimation of the first OFDM symbol and the eighth OFDM symbol as a virtual preamble, and performing a DPA estimation of the remaining OFDM symbols by using a virtual preamble;
placing a DPA estimation result at a corresponding position of a real channel matrix, and performing a linear interpolation on two dimensions of OFDM symbols and subcarriers;
separating a real part and an imaginary part of an interpolation result as the input data of the model to be trained.

In some embodiments, in S2, the multi-dimensional feature aggregation module aggregates the features of the input data on multiple dimensions, including a spatial feature aggregation block and a channel feature aggregation block; the spatial feature aggregation block extracts the spatial features of the input data from a time direction and a frequency direction; the channel feature aggregation block extracts the channel features of the input data from the channel direction.

In some embodiments, the spatial feature aggregation block includes a spatial self-attention block and a feedforward network;
the spatial self-attention block consists of three parallel branches, the first branch divides the input data into 72 patches with a feature dimension of 16 along the frequency direction, and then implements a multi-head attention mechanism to extract the spatial features of the input data from the frequency dimension; the second branch divides the input data into 14 patches with a feature dimension of 16 along the time direction, and then implements a multi-head attention mechanism to extract the spatial features of the input data from the time dimension; the third branch extracts local features from the input data through a convolutional layer; the first two branches fuse the spatial features of frequency dimension and time dimension by matrix multiplication, and the results are added with the third branch to obtain an output of the spatial self-attention block;
the feedforward network uses a LayerNorm layer, two linear layers, and an activation layer to process the features extracted by the spatial self-attention block.

In some embodiments, the channel feature aggregation block includes a channel self-attention block and a feedforward network; the channel self-attention block consists of two parallel branches; the first branch averages the input data, and then implements the multi-head attention mechanism to extract the channel features of the input data from the channel dimension; the second branch extracts local features from the input data through a convolutional layer; the feedforward network uses a LayerNorm layer, two linear layers and an activation layer to process the features extracted by the two branches.

In some embodiments, the feature processing module further processes the extracted features; first, a convolutional layer is used to preprocess the features extracted by the multi-dimensional feature aggregation module, and then four consecutive RBs are used for feature processing; the output of the last RB will pass through a convolutional layer to obtain the result of feature processing, and the output of these two convolutional layers is connected through a residual structure.

In some embodiments, RB is composed of a convolutional layer, an activation layer with an activation function of Gelu, and a convolutional layer, and the input and output of RB are connected by a residual structure.

In some embodiments, the upsampling module restores the processed features to a target size and uses the upsampling method of Pixel Shuffle.

In some embodiments, in S4, the process of data preprocessing of a received signal by the AUV at the receiving end is consistent with the upsampling step of the pilot signal by the interpolation method of DPA estimation.

In some embodiments, in S5, AUV loads the FACENet model completed by offline training, inputs the received data preprocessed into FACENet, and estimates the real channel frequency response of the current AUV environment through model calculation.

Therefore, the invention adopts the above-mentioned channel estimation method of a multi-dimensional feature aggregation network based on an AUV wireless communication system, and its technical effect is as follows:

(1) The invention uses the self-attention mechanism in deep learning to build a multi-dimensional feature aggregation network for channel estimation. The network aggregates the spatial and channel features of the input data by alternately using spatial self-attention and channel self-attention, and processes these features through a deep residual network. Considering that the channel has a strong correlation in time and frequency, spatial self-attention obtains and fuses the spatial features from the direction of time and frequency, respectively. This network design combines the characteristics of deep learning and OFDM signals, which can better extract the characteristics of input data, so that the estimation performance of the network is much better than the traditional channel estimation, and compared with other channel estimation schemes based on deep learning, it also presents better performance.

(2) The invention uses an interpolation method based on DPA estimation to upsample the pilot signal, by using the OFDM symbol containing the pilot as a virtual preamble, the virtual preamble is used to perform DPA estimation on the remaining OFDM symbols, and linear interpolation is performed on the two dimensions of the OFDM symbol and the subcarrier, so that the network can support flexible pilot patterns and maximize the use of pilot signals.

(3) The time and space complexity of the multi-dimensional feature aggregation network constructed by the invention is low; firstly, the time required to complete the channel estimation of an OFDM subframe is 1.6863 ms; it can be seen that the delay caused by the calculation is allowed in the communication environment of the real AUV. Moreover, the operations carried out in the network model are multiplication, division, addition, and subtraction, so the implementation on the hardware is not particularly difficult. Secondly, the number of model parameters of the multi-dimensional feature aggregation network is 66,746, which is significantly reduced compared with other deep learning-based channel estimation networks such as ChannlNet (the number of model parameters is 678,658), CRCENet (the number of model parameters is 961,238), etc. Therefore, the multi-dimensional feature aggregation network constructed by the invention is suitable for application to AUVs.

The following is a further detailed description of the technical scheme of the invention through drawings and implementation examples.

### BRIEF DESCRIPTION OF THE DRAWINGS

FIG. 1 is a flow chart of implementing deep learning channel estimation on an AUV.

FIG. 2 is a schematic diagram of the pilot scheme used in the invention;

FIG. 3 is a schematic diagram of the network architecture of the multi-dimensional feature aggregation network constructed by the invention;

FIG. 4 is a network architecture diagram of the multi-dimensional feature aggregation module in the multi-dimensional feature aggregation network;

FIG. 5 is a network architecture diagram of the spatial self-attention block in the multi-dimensional feature aggregation module;

FIG. 6 is a network architecture diagram of the channel self-attention block in the multi-dimensional feature aggregation module;

FIG. 7 is an interpolation flow chart of the interpolation scheme based on DPA estimation.

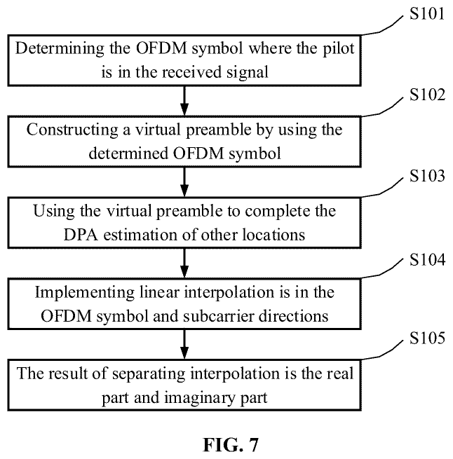

FIG. 8 is a simulation flow chart of the channel estimation method based on a multi-dimensional feature aggregation network.

FIG. 9 is an MSE performance simulation diagram of various channel estimation methods.

FIG. 10 is a BER performance simulation diagram of various channel estimation methods.

### DETAILED DESCRIPTION OF THE EMBODIMENTS

The following is a further explanation of the technical scheme of the invention through drawings and implementation examples.

Unless otherwise defined, the technical terms or scientific terms used in the invention should be understood by people with general skills in the field to which the invention belongs.

### Embodiment 1

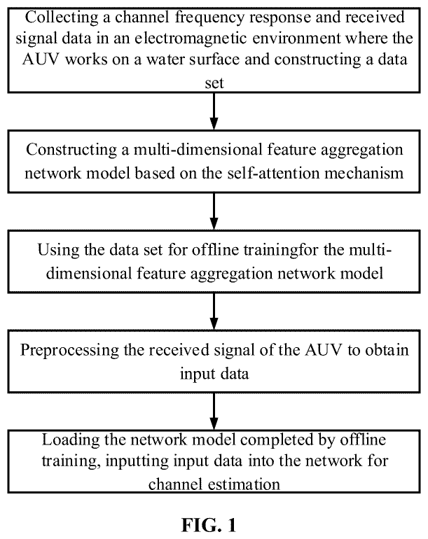

As shown in FIG. 1, the invention provides a channel estimation method of a multi-dimensional feature aggregation network based on an AUV wireless communication system, including the following steps:

S1, the channel frequency response and the received signal data in an electromagnetic environment where the AUV works on the water surface are collected, extracting a pilot signal from received signals, and the channel frequency response in the collected data is used as a training label and corresponds to the received signal data to form a data set.

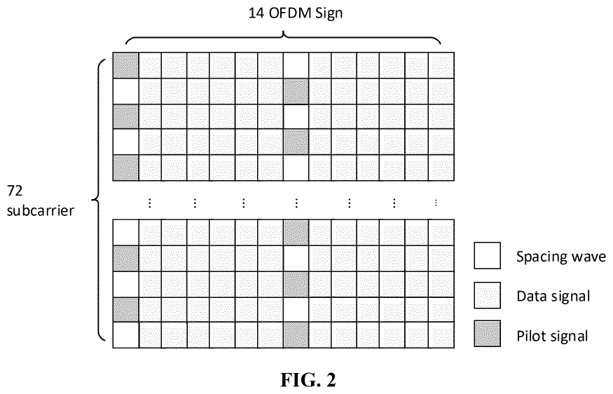

The data set is collected on the surface of the sea area where the AUV works, each type of sea area can be defined as a type of channel model. The data set under each type of channel model covers the received signal data and channel frequency response data under different signal-to-noise ratios (5-25 dB, with 5 dB as the interval). The received signal data is collected according to the AUV receiver, and the channel frequency response data is collected according to the dedicated channel measurement equipment. In the collected data, the pilot signal is extracted from the received signal, and the pilot signal is up-sampled by the interpolation method based on DPA estimation as the input data of the model to be trained, and the corresponding channel frequency response is used as the label. The pilot signal extracted from the received signal is distributed in a 32×2 manner in the first OFDM symbol and the eighth OFDM symbol of the 72×14 time-frequency grid, as shown in FIG. 2. The pilot signal is emitted by the shore-based transmitter or other AUV transmitter with the transmitted data, and its value is 1+1j. The interpolation method based on DPA estimation to upsample the pilot signal includes the following steps:

S11, for the first OFDM symbol and the eighth OFDM symbol, LS estimation is performed at the pilot position using Formula (1):

$${\hat{H}}_{p}^{LS} = \frac{{Y}_{p}}{{X}_{p}} ; \qquad ( 1 )$$

in Formula (1), Xₚ denotes the transmitted pilot signal, Yₚ denotes the received signal at the pilot, and

$${\hat{H}}_{p}^{LS}$$

denotes the LS estimation result at the pilot;

For example, the position of the pilot in the OFDM subframe is known to both sides of the communication (shore-based and AUV, AUV and AUV) before communication. In this embodiment, the pilot is in the first OFDM symbol in the OFDM subframe. The 1st, 3rd, 5th, . . . , 71st subcarrier positions and the 2nd, 4th, 6th, . . . , 72nd subcarrier positions in the 8th OFDM symbol are generally distributed in a 32×2 grid in a 72×14 time-frequency grid, as shown in FIG. 2.

S12, the LS estimation of the first eighth OFDM symbol is used as the virtual preamble, and the DPA estimation of the remaining OFDM symbols is performed using the virtual preamble. The DPA estimation is shown in Formula (2) and Formula (3):

$${y}_{{eq}_{i}} = \frac{{y}_{i}}{{\hat{h}}_{i - 1}^{DPA}} , {\hat{h}}_{0}^{DPA} = {\hat{h}}_{0}^{LS} ; \qquad ( 2 )$$

$${\hat{h}}_{i}^{DPA} = \frac{{y}_{i}}{{d}_{i}} ; \qquad ( 3 )$$

In Formula (2) and Formula (3), yᵢ is the i-th received OFDM symbol,

$${\hat{h}}_{i}^{DPA}$$

is the DPA estimation of the i-th OFDM symbol, y_{eq}_{ᵢ} is the i-th balanced OFDM symbol, dᵢ is the balanced OFDM symbol which is mapped to the nearest constellation point.

Making a virtual preamble includes the following specific steps:

The corresponding LS estimation is calculated by using Formula (1) for the 1st, 3rd, 5th, . . . , 71 subcarrier positions in the first OFDM symbol; the channel estimation values at the 2nd, 4th, 6th, . . . , 72 subcarrier positions are set to 0, and the processed first OFDM symbol is used as the first virtual preamble. Similarly, for the 2nd, 4th, 6th, . . . , 72 sub-carrier positions in the 8th OFDM symbol, the corresponding LS estimation is calculated by using Formula (1); the channel estimation values at the 1st, 3rd, 5th, . . . , 71 sub-carrier positions are set to 0, and the processed 8th OFDM symbol is used as the second virtual leading.

S13, the estimation results are placed in the corresponding position of the real channel matrix, and linear interpolation is performed on the two dimensions of OFDM symbols and subcarriers.

DPA estimation at other locations includes the following specific steps:

The 1st, 3rd, 5th, . . . , 71 subcarrier positions on the 2-14 OFDM symbols are estimated by DPA as shown in Formula (2) and Formula (3), and the first virtual preamble is made at this time. Similarly, the DPA estimation of the 2nd, 4th, 6th, . . . , and 72nd subcarrier positions on the 9th to 14th OFDM symbols is performed as shown in Formula (2) and Formula (3). For other locations involving DPA estimation, the channel estimation values are all set to 0.

In S104, the linear interpolation is shown in Formula (4):

$$y = {y}_{1} + ( {y}_{2} - {y}_{1} ) \times \frac{x - {x}_{1}}{{x}_{2} - {x}_{1}} ; \qquad ( 4 )$$

where (x₁, y₁) and (x₂, y₂) are the two known data points closest to the interpolation point (x,y) By performing linear interpolation in both OFDM symbols and subcarriers, the completed DPA estimation results can be upsampled to the scale of the complete OFDM subframe, that is, 72×14.

S14, the real part and the imaginary part of the interpolation result are separated and used as the third dimension of the input data; the input Ĥᵢₙₚᵤₜ [symbol] of the model obtained is used as the input data of the model to be trained.

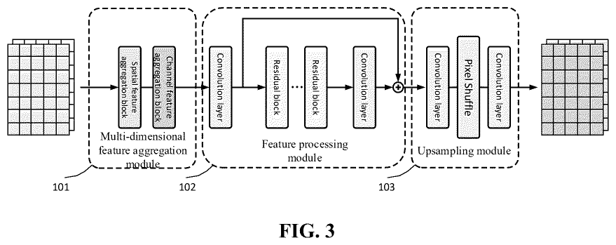

S2, a multi-dimensional feature aggregation network model is constructed based on a self-attention mechanism for AUV;
the multi-dimensional feature aggregation network model FACENet based on self-attention mechanism includes a multi-dimensional feature aggregation module, a feature processing module and an upsampling module, as shown in FIG. 3. Among them, the multi-dimensional feature aggregation module aggregates the features of the input data on multiple dimensions, and extracts the input features to the greatest extent; the feature processing module further processes the extracted features; the upsampling module restores the processed features to the target size.

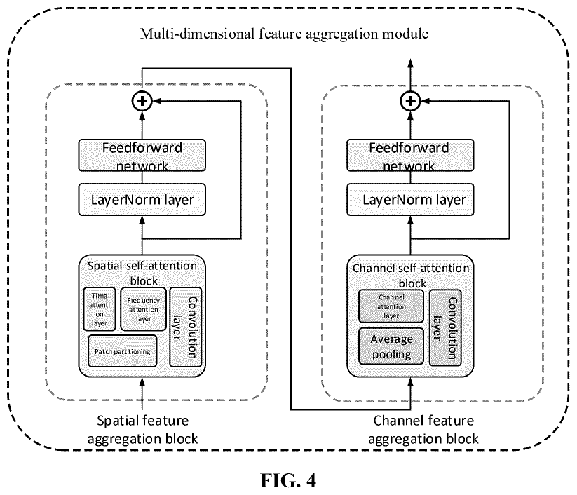

The multi-dimensional feature aggregation module is the core of the multi-dimensional feature aggregation network, which will aggregate the features of the input data from multiple dimensions. The module consists of a continuous spatial feature aggregation block (SFAB) and a channel feature aggregation block (CFAB), as shown in FIG. 4.

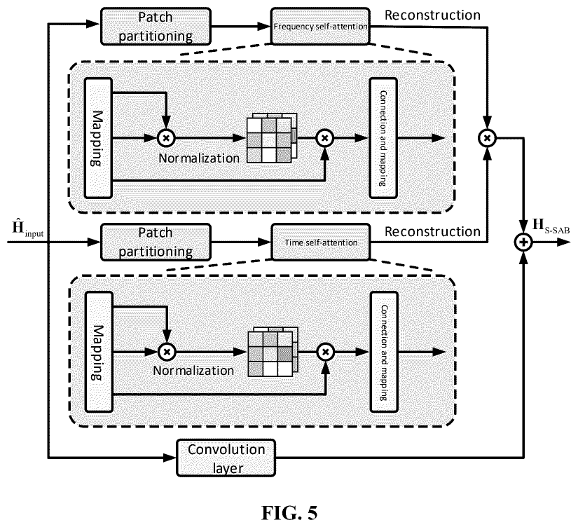

The SFAB consists of a spatial self-attention block (S-SAB) and a feedforward network (FFN), as shown in FIG. 5, the core of the SFAB is on the S-SAB. Considering that the channel has a strong correlation in time and frequency, spatial self-attention obtains and fuses spatial features from the direction of time and frequency, respectively. In this regard, S-SAB first uses the idea of visual Transformer (VIT) to divide the input data into several patches along the direction of time and frequency, and then implements self-attention on these patches. Finally, by matrix multiplication, the features extracted in these two directions can be fused to obtain the features of the input data in the spatial dimension. Similarly, CFAB consists of a channel self-attention block (C-SAB) and an FNN, the core of which is on the C-SAB. C-SAB averages the spatial features extracted by S-SAB, and the results are self-attention in the channel direction, so as to obtain the features in the channel dimension. It is noted that C-SAB completes the downsampling while performing the average pooling operation, which makes the subsequent feature processing on a small scale, reducing the model parameters and computational complexity. Considering that the features extracted by the self-attention mechanism are global features, we implement a parallel convolution layer in both S-SAB and C-SAB to obtain local features, the local features obtained by convolution are added to the corresponding elements of the global features obtained by self-attention, and the corresponding outputs of S-SAB and C-SAB are obtained.

The spatial self-attention block is composed of three parallel branches, the first branch divides the input data into 72 patches with 16 feature dimensions along the frequency direction, and then implements the multi-head attention mechanism to extract the spatial features of the input data from the frequency dimension. The second branch divides the input data into 14 patches with a feature dimension of 16 along the time direction, and then implements a multi-head attention mechanism to extract the spatial features of the input data from the time dimension. The third branch extracts local features from the input data through a convolutional layer, the first two branches fuse the spatial features of the frequency dimension and the time dimension by matrix multiplication, and the results are added with the third branch to obtain the output of the spatial self-attention block. The feedforward network uses a LayerNorm layer, two linear layers, and an activation layer to process the features extracted by the spatial self-attention block.

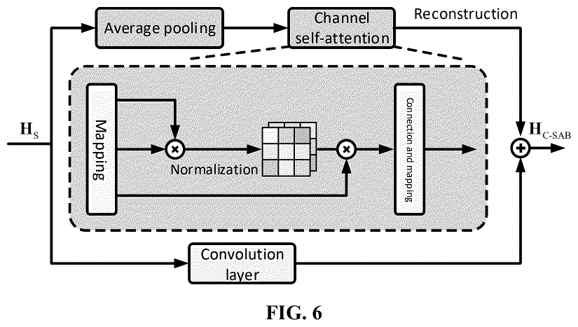

The channel feature aggregation block includes a channel self-attention block and a feedforward network. As shown in FIG. 6, the channel self-attention block consists of two parallel branches, the first branch averages the input data, and then implements the multi-head attention mechanism to extract the channel features of the input data from the channel dimension. The second branch extracts local features from the input data through a convolutional layer, the feedforward network uses a LayerNorm layer, two linear layers, and an activation layer to process the features extracted by the two branches.

Spatial Self-Attention Block (S-SAB): As shown in FIG. 5, S-SAB has three branches; the first two branches are used to obtain the spatial features of the input data (from the direction of time and frequency, respectively), and the last branch is used to obtain the local features of the input data. For the input data Ĥᵢₙₚᵤₜ [symbol] , the first branch will first divide it into K patches with a feature dimension of Nₑ along the frequency direction, and the set of these patches is X_{f} [symbol] . The specific operation of patch partitioning is as follows: the input data Ĥᵢₙₚᵤₜ passes through a convolutional layer with a convolution kernel size of (1,1), the filter number is Nₑ, and the stride of 1, and the obtained output H_{f} [symbol] is reconstructed as X_{f}. The frequency self-attention layer (F-SA) will implement multi-head self-attention along the frequency direction. First, X_{f} are mapped to the matrices of query (Q), key(K) and value(V) with a size of K×Nₑ by the following formula:

$${Q}_{f} = {X}_{f} {W}_{Q} , {K}_{f} = {X}_{f} {W}_{K} , {V}_{f} = {X}_{f} {W}_{V} , \qquad ( 5 )$$

Where W_{Q}, W_{K}, W_{V} ∈Π^{N}^{ₑ}^{×N}^{ₑ} denotes the linear mapping that omits the bias, the subscript f denotes the implemented frequency multi-head self-attention.

Then, Q_{f}, K_{f}, V_{f} is separated into N_{head} heads:

$${Q}_{f} = [ {Q}_{f}^{1} , … , {Q}_{f}^{{N}_{head}} ] ,$$

$${K}_{f} = [ {K}_{f}^{1} , … , {K}_{f}^{{N}_{head}} ] , {V}_{f} = [ {V}_{f}^{1} , … , {V}_{f}^{{N}_{head}} ] .$$

The dimension of each head is d=Nₑ/N_{head}. The output

$${Y}_{f}^{i}$$

of the i-th head is calculated by the following formula:

$${Y}_{f}^{i} = softmax ( \frac{{{Q}_{f}^{i} ( {K}_{f}^{i} )}^{T}}{\sqrt{d}} ) {V}_{f}^{i} . \qquad ( 6 ) ;$$

finally, the output Y_{f} of F-SA can be obtained by connecting the outputs of all heads and performing linear mapping:

$${Y}_{f} = concat ( {Y}_{f}^{1} , … . , {Y}_{f}^{{N}_{h e a d}} ) {W}_{f} , \qquad ( 7 ) ;$$

where W_{f} [symbol] denotes the linear mapping that omits the bias, and the subscript f denotes the implemented frequency multi-head self-attention.

For the input data Ĥᵢₙₚᵤₜ the second branch first divides it into I patches with a feature dimension of Nₑ along the time direction, and the set of these patches is Xₜ [symbol] . Please note that the convolution kernel size of the convolution layer used in this patch division is (K,1). The time self-attention layer (T-SA) will implement multi-head self-attention along the time direction, and its steps are completely consistent with F-SA. It is worth noting that Qₜ, Kₜ, Vₜ, Yₜ [symbol] , they are different from the dimensions of Q_{f}, K_{f}, V_{f}, Y_{f} in F-SA, and the subscript t denotes the implemented frequency multi-head self-attention.

In order to fuse the spatial feature Y_{f} extracted by self-attention along the frequency with the spatial feature Yₜ extracted by self-attention along the time, a Reshape operation needs to be performed first to obtain

$${Y}_{f}^{′} ∈ {▯}^{K \times 1 \times {N}_{e}}$$

and

$${Y}_{t}^{′} ∈ {▯}^{I \times 1 \times {N}_{e}} .$$

Then the matrix multiplication is performed to obtain the spatial feature

$${Y}_{S}^{G} ∈ {▯}^{K \times I \times {N}_{e}} ,$$

as shown in the following formula:

$${Y}_{S}^{G} = {{Y}_{f}^{′} ( {Y}_{t}^{′} )}^{T} . \qquad ( 8 ) ;$$

the third branch implements a convolution layer with a convolution kernel size of (Nₖₑᵣₙₑₗ, Nₖₑᵣₙₑₗ), a filter number of Nₑ, and a stride of 1 to extract the local features of the input data. The result after convolution is

$${Y}_{S}^{L} ∈ {▯}^{K \times I \times {N}_{e}} .$$

Finally, the output H_{S-SAB} [symbol] S-SA can be obtained by adding the corresponding elements of

$${Y}_{S}^{L} and {Y}_{S}^{G} .$$

The feedforward network (FFN): SFAB includes an LN layer, an FNN, and a residual structure in addition to the S-SAB. FFN includes two linear mappings W₁ [symbol] , W₂ [symbol] that omit the bias and an activation layer GeLU. The output H_{S} [symbol] of the SFAB is obtained after the output H_{S-SAB} of the S-SAB passes through the FFN.

Channel self-attention block (C-SAB): As shown in FIG. 6, C-SAB has two branches. The first branch is used to obtain the channel features of the input data, and the second branch is used to obtain the local features of the input data. For the input data H_{S} the first branch first performs average pooling, the pool size is N_{d}×N_{d} and the stride is N_{d}×N_{d}. The pooling result X_{AP} [symbol] will be reconstructed into

$${X}_{C} ∈ {▯}^{{N}_{e} \times ( KI / {N}_{d}^{2} )}$$

as the input of channel self-attention (C-SA). X_{C} is processed by C-SA according to Formulas (5)-(7), and the matrix generated is

$${Q}_{C} , {K}_{C} , {V}_{C} ∈ {▯}^{{N}_{e} \times ( KI / {N}_{d}^{2} )} ,$$

the linear mappings

$${W}_{Q} , {W}_{K} , {W}_{V} , {W}_{C} ∈ {▯}^{( KI / {N}_{d}^{2} ) \times ( KI / {N}_{d}^{2} )}$$

that omit the bias. The output Y_{C} [symbol] of C-SA extracts the channel features of the input data. Another branch implements a convolution layer with a convolution kernel size of N_{d}×N_{d}, a filter number of Nₑ, and a stride of N_{d}×N_{d} to extract the local features of the input data. The result after convolution is

$${Y}_{C}^{L} ∈ {▯}^{( K / {N}_{d} ) \times ( I / {N}_{d} ) \times {N}_{e}} .$$

Finally, it is required to reconstruct Y_{C} into

$${Y}_{C}^{G} ∈ {▯}^{( K / {N}_{d} ) \times ( I / {N}_{d} ) \times {N}_{e}} ,$$

and then it is added to the corresponding element of

$${{Y}_{C}^{L}}_{ }$$

to obtain the output H_{C-SABE} [symbol] of C-SAB.

Like S-SAB, C-SAB is followed by an identical LN layer, FNN, and residual structure. For the output H_{C-SAB} of C-SAB, the output H_{C} [symbol] of CFAM is obtained.

The feature processing module further processes the extracted features. Firstly, a convolutional layer is used to preprocess the features extracted by the multi-dimensional feature aggregation module, and then four consecutive RBs are used for feature processing, the output of the last RB will be obtained through a convolutional layer, the results of feature processing, and the output of these two convolutional layers is connected through a residual structure. For example, the feature processing module consists of N_{RB} RBs, each RB consists of two identical convolutional layers, an activation layer, and a residual structure. The convolution kernel size of the convolution layer is Nₖₑᵣₙₑₗ×Nₖₑᵣₙₑₗ and the filter number is Nₑ The activation function of the activation layer is ReLU. The residual structure adds the input and output of RB. There are two convolution layers before and after the feature processing module, which is exactly the same as the convolution layer in RB. After passing through the first convolution layer, the output H_{C} of module 101 will be used as the input of the feature processing module. The output of the module is added to the input through a residual structure after passing through the second convolution layer to obtain the processed feature HE ∈ [symbol] .

The upsampling module restores the processed features to the target size and uses the upsampling method of Pixel Shuffle. For example, it is completed by using the pixel shuffle method, H is used to restore the size of the real channel matrix through the upsampling module. Before pixel shuffle, there is a convolution layer with a convolution kernel size of Nₖₑᵣₙₑₗ×Nₖₑᵣₙₑₗ and a filter number Nₑ×N_{d} of to provide sufficient depth features for pixel shuffle. After pixel shuffle, there is a convolution layer with a convolution kernel size of Nₖₑᵣₙₑₗ×Nₖₑᵣₙₑₗ and a filter number of 2, which is used to match the number of output channels with the number of channels of the label, and the output of the upsampling layer is Ĥ_{FACENet} [symbol] .

For the multi-dimensional feature aggregation network, we set the parameters in the network framework as follows: Nₑ=16, N_{head}=2, Nₖₑᵣₙₑₗ=3, N_{d}=4, N_{RB}=4. Finally, the network training parameters totaled 66,746.

S3, in the multi-dimensional feature aggregation network model established in S2, the data set collected in S1 is used for offline training to obtain the trained network model. For example, FACENet performs offline training under hyperparameters with a learning rate of 0.001, an optimizer of Adam, a loss function of L1 loss, a batch size of 128, and a training cycle of 100 to obtain the trained weights.

S4, when the AUV works on the water surface, the received signal is preprocessed at the receiving end of the AUV to obtain the input data of the network model completed by S3 training; the process of data preprocessing of the received signal at the receiving end of the AUV is consistent with that of S11-S14.

S5, the input data obtained from S4 is input into the network model trained by S3, and the real channel frequency response of the AUV environment is estimated to complete the channel estimation.

### Embodiment 2

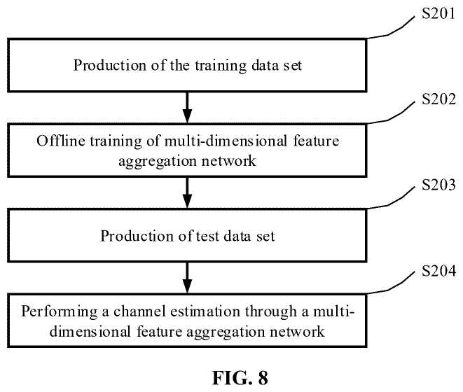

As shown in FIG. 8, a channel estimation method of a multi-dimensional feature aggregation network based on an AUV wireless communication system is also provided, including the following steps:

### Step 1: Production of Training Data Sets

Matlab 2023 a is used to simulate the marine channel environment, and the training data set is made by simulation. Considering the SISO-OFDM system, for each time slot in an OFDM subframe, there are 14 OFDM symbols, and each OFDM symbol has 72 subcarriers. The pilot is arranged in a 36×2 lattice form in the transmission symbol. The modulation mode of the signal in the system is divided into QPSK. The channel model is the maritime multipath channel model. The subcarrier frequency is 2.1 GHZ, the carrier frequency is 15 kHz, the sampling frequency is 1.08 MHz, and the AUV speed is 50 km/h. The training data set is generated under the above system parameters. The signal-to-noise ratio (SNR) is between 5 dB and 25 dB with an interval of 5 dB. Each SNR generates 10,000 samples and a total of 50,000 channels are implemented. The ratio of the training set to the validation set in the training data set is 3:1.

### Step 2: Offline Training of a Multi-Dimensional Feature Aggregation Network;

the multi-dimensional feature aggregation network FACENet is trained offline in NVIDIA GeForce RTX 3080, Tensorflow-2.5.0 under the hyperparameters, in which the learning rate is 0.001, the optimizer is Adam, the loss function is L1 loss, the batch size is 128, and the training period is 100, and then the trained weights are obtained.

### Step 3: Production of the Test Data Set.

The system parameters that generate the test data set are consistent with the training data set except for the AUV's moving speed. SNR in 0 dB to 30 dB with 5 dB interval, each SNR generates 2500 samples, a total of 17500 channels are implemented. For each signal-to-noise ratio sample, the receiver speed is randomly selected from 0 to 50 km/h, that is, the Doppler frequency range of the 2500 samples is 0 to 97 Hz.

### Step 4: Channel Estimation Through a Multi-Dimensional Feature Aggregation Network

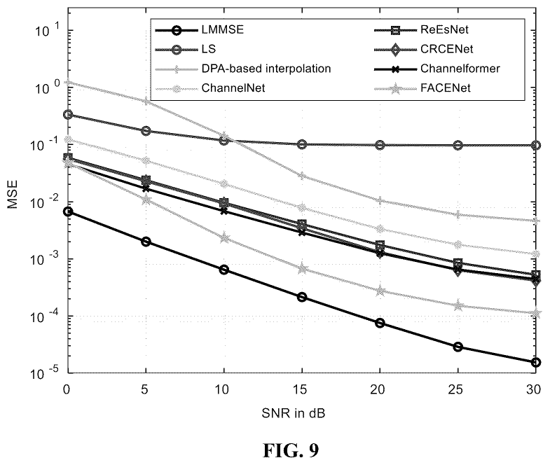

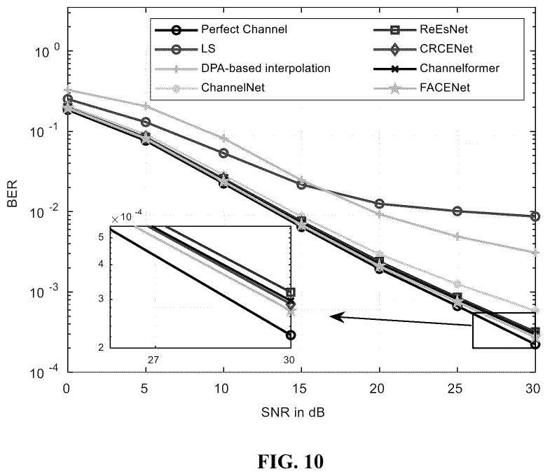

The trained FACENet is used to test the test data set, and the results of channel estimation are obtained. As shown in FIG. 8 and FIG. 9, the figures are the minimum mean square error (MSE) and system bit error rate (BER) of channel estimation using FACENet, respectively. The CRCENet, Channelformer, ChannelNet, and ReEsNet in the figures are other deep learning channel estimation schemes, and LMMSE, LS, and DPA-interpolation are non-deep learning channel estimation schemes for comparison. It can be seen from FIG. 9 that FACENet has the smallest MSE and the best estimation performance under full SNR. As can be seen from FIG. 10, FACENet has the smallest BER and the highest system reliability at full signal-to-noise ratio.

Therefore, the invention adopts the above-mentioned channel estimation method of a multi-dimensional feature aggregation network based on an AUV wireless communication system. The space-time complexity of the network model involved is low, and it can be applied to AUV through offline training to achieve far better estimation performance than the traditional channel estimation method, thereby solving the above-mentioned technical problems in the existing technology.

Finally, it should be explained that the above embodiments are only used to explain the technical scheme of the invention rather than restrict it. Although the invention is described in detail with reference to the better embodiment, the ordinary technical personnel in this field should understand that they can still modify or replace the technical scheme of the invention, and these modifications or equivalent substitutions cannot make the modified technical scheme out of the spirit and scope of the technical scheme of the invention.

What is claimed is:

1. A channel estimation method of a multi-dimensional feature aggregation network based on an AUV wireless communication system, comprising the following steps:
S1, collecting a channel frequency response and received signal data in an electromagnetic environment where an AUV works on a water surface, extracting a pilot signal from received signals, and using an interpolation method based on DPA estimation to upsample the pilot signal as an input data of a model to be trained; using a channel frequency response in collected data as a training label; and corresponding the training label to the received signal data to form a data set;
S2, constructing a multi-dimensional feature aggregation network model based on a self-attention mechanism; wherein a multi-dimensional feature aggregation network model FACENet based on the self-attention mechanism comprises a multi-dimensional feature aggregation module, a feature processing module, and an upsampling module;
wherein the multi-dimensional feature aggregation module aggregates the features of the input data on multiple dimensions, including a spatial feature aggregation block and a channel feature aggregation block; the spatial feature aggregation block extracts the spatial features of the input data from a time direction and a frequency direction; and the channel feature aggregation block extracts the channel features of the input data from the channel direction;
S3, in the multi-dimensional feature aggregation network model established in S2, using the data set collected in S1 for offline training to obtain a trained network model;
S4, when the AUV works on the water surface, preprocessing the received signal at a receiving end of the AUV to obtain input data of the network model trained in S3; and
S5, inputting the input data obtained in S4 into the network model trained by S3, and estimating a real channel frequency response of the AUV environment to complete a channel estimation.

2. The channel estimation method of the multi-dimensional feature aggregation network based on the AUV wireless communication system according to claim 1, wherein in S1, using the interpolation method based on DPA estimation to upsample the pilot signal comprises the following steps:
for a first OFDM symbol and an eighth OFDM symbol, performing an LS estimation at a pilot position;
using the LS estimation of the first OFDM symbol and the eighth OFDM symbol as a virtual preamble, and performing a DPA estimation of the remaining OFDM symbols by using a virtual preamble;
placing a DPA estimation result at a corresponding position of a real channel matrix, and performing a linear interpolation on two dimensions of OFDM symbols and subcarriers; and
separating a real part and an imaginary part of an interpolation result as the input data of the model to be trained.

3. The channel estimation method of the multi-dimensional feature aggregation network based on the AUV wireless communication system according to claim 1, wherein the spatial feature aggregation block comprises a spatial self-attention block and a feedforward network;
wherein the spatial self-attention block consists of three parallel branches, the first branch divides the input data into 72 patches with a feature dimension of 16 along the frequency direction, and then implements a multi-head attention mechanism to extract the spatial features of the input data from the frequency dimension; the second branch divides the input data into 14 patches with a feature dimension of 16 along the time direction, and then implements a multi-head attention mechanism to extract the spatial features of the input data from the time dimension; the third branch extracts local features from the input data through a convolutional layer; the first two branches fuse the spatial features of frequency dimension and time dimension by matrix multiplication, and the results are added with the third branch to obtain an output of the spatial self-attention block; and
the feedforward network uses a LayerNorm layer, two linear layers, and an activation layer to process the features extracted by the spatial self-attention block.

4. The channel estimation method of the multi-dimensional feature aggregation network based on the AUV wireless communication system according to claim 1, wherein the channel feature aggregation block comprises a channel self-attention block and a feedforward network; the channel self-attention block consists of two parallel branches; the first branch averages the input data, and then implements the multi-head attention mechanism to extract the channel features of the input data from the channel dimension; the second branch extracts local features from the input data through a convolutional layer; the feedforward network uses a LayerNorm layer, two linear layers and an activation layer to process the features extracted by the two branches.

5. The channel estimation method of the multi-dimensional feature aggregation network based on the AUV wireless communication system according to claim 1, wherein the feature processing module further processes the extracted features; first, a convolutional layer is used to preprocess the features extracted by the multi-dimensional feature aggregation module, and then four consecutive RBs are used for feature processing; wherein the output of the last RB will pass through a convolutional layer to obtain the result of feature processing, and the output of these two convolutional layers is connected through a residual structure.

6. The channel estimation method of the multi-dimensional feature aggregation network based on the AUV wireless communication system according to claim 5, wherein RB is composed of a convolutional layer, an activation layer with an activation function of Gelu, and a convolutional layer, and the input and output of RB are connected by a residual structure.

7. The channel estimation method of the multi-dimensional feature aggregation network based on the AUV wireless communication system according to claim 1, wherein the upsampling module restores the processed features to a target size and uses the upsampling method of Pixel Shuffle.

8. The channel estimation method of the multi-dimensional feature aggregation network based on the AUV wireless communication system according to claim 1, wherein in S4, the process of data preprocessing of a received signal by the AUV at the receiving end is consistent with the upsampling step of the pilot signal by the interpolation method of DPA estimation.

9. The channel estimation method of the multi-dimensional feature aggregation network based on the AUV wireless communication system according to claim 1, wherein in S5, AUV loads the FACENet model completed by offline training, inputs the received data preprocessed into FACENet, and estimates the real channel frequency response of the current AUV environment through model calculation.
